(19) United States
(12) Patent Application Publication
(10) Pub. No.: US 2005/0145553 A1
(43) Pub. Date: Jul. 7, 2005

(54) Chemical supply system

(76) Inventor: Cheng-Hwa Cheng, San-Wan Hsiang (TW)

Correspondence Address: BIRCH STEWART KOLASCH & BIRCH, PO BOX 747, FALLS CHURCH, VA, 22040-0747, US

(21) Appl. No.: 10/751,400

(22) Filed: Jan. 6, 2004

(51) Int. Cl. B01D 35/01

(52) U.S. Cl. 210/257.1

(57) ABSTRACT

A chemical supply system is provided. The present system provides a first system including a first tank for storing a chemical liquid therein and a first filter connecting with the first tank by a first tube and a second tube. A third tube connects the first system with a second system. The second system includes a second tank and a second filter connecting with the second tank by a fourth tube and a fifth tube. A first vent tube connects with the first tank. A second vent tube connects with the second filter.

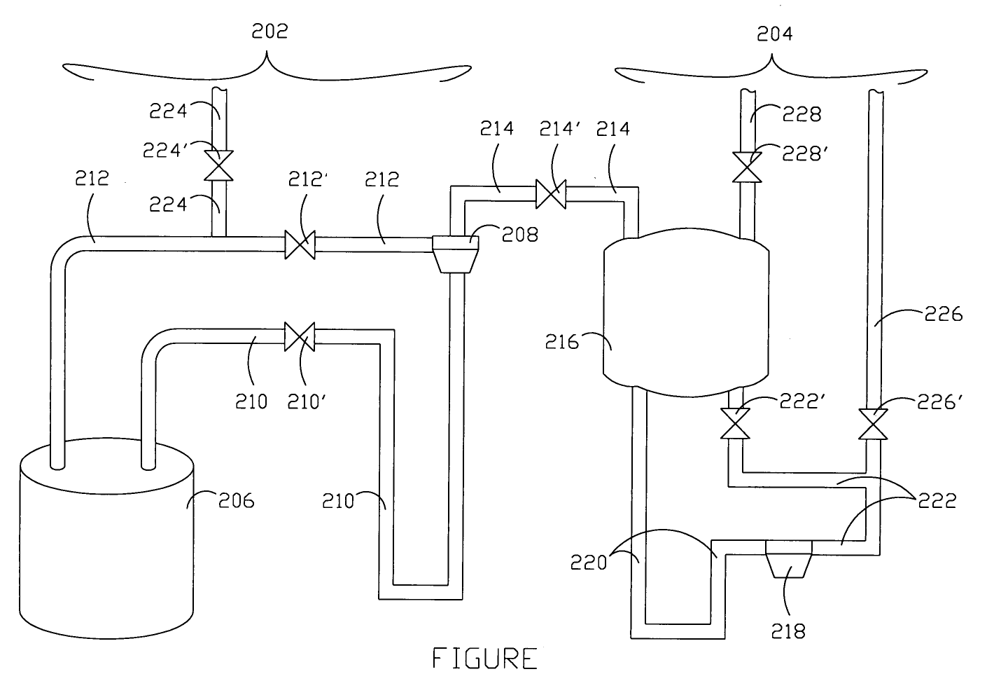

### BACKGROUND OF THE INVENTION

1. Field of the Invention

The present invention relates to a chemical supply system, and more particularly to a chemical supply system for manufacturing semiconductor devices.

2. Description of the Prior Art

Kinds of chemical liquids are utilized for manufacturing semiconductor devices. Before utilizing the chemical liquids, the chemical liquids have to be filtered to reduce particles for preventing semiconductor devices from pollution of particles. If the chemical liquid is not pure enough, the yield for manufacturing semiconductor devices may be reduced.

A chemical supply system filters a chemical liquid for manufacturing semiconductor devices. The chemical supply system may include filters, tubes and tanks. If elements of the chemical supply system are broken down, the step for filtering the chemical liquid has to be stop. The time for manufacturing semiconductor devices lasts longer due to the broken elements.

Some gas is transported into tanks for piping the chemical liquid through tubes. If the gas is transported to the filters, the gas has to be vented out for preventing the filters from deweting. However, portions of the chemical liquid may be vented and wasted when venting gas stored inside the filters. If the quantity of the vented gas and the wasted chemical liquid becomes more, the cost for disposing of the vented gas and the vented chemical liquid becomes more. Because some chemical liquid is very expensive. The cost of the wasted chemical liquid is also very much.

According to the above description, it is necessary to develop a chemical supply system to maintain the yield and the time for manufacturing semiconductor devices, reduce the cost for disposing of the vented gas and the vented chemical liquid, and reduce the quantity of the chemical liquid and gas.

### SUMMARY OF THE INVENTION

In accordance with the present invention, a chemical supply system is provided to substantially overcome the drawbacks of the above mentioned problems for manufacturing semiconductor devices.

Accordingly, it is one objective of the present invention to provide a chemical supply system for manufacturing semiconductor devices. The present invention economizes the cost for disposing of a wasted liquid composed of gas and some of the chemical liquid.

It is another objective of the present invention to provide a chemical supply system for manufacturing semiconductor devices. The present invention reduces the quantity of gas and the chemical liquid.

It is a further objective of the present invention to provide a chemical supply system for manufacturing semiconductor devices. The present invention provides a purer chemical liquid by filtering the chemical liquid through more filtering steps.

It is a further objective of the present invention to provide a chemical supply system for manufacturing semiconductor devices. The present invention maintains the yield for manufacturing semiconductor devices by providing a purer chemical liquid.

It is a further objective of the present invention to provide a chemical supply system for manufacturing semiconductor devices. The present invention reduces the time to supply the purer chemical liquid for manufacturing semiconductor devices due to a plurality of independent operated systems of the chemical supply system.

It is a further objective of the present invention to provide a chemical supply system for manufacturing semiconductor devices. The present invention operates independent operated systems without broken elements of the chemical supply system continuously when elements of other independent operated systems of the chemical supply system are broken down.

In accordance with the present invention, a chemical supply system is disclosed. The present chemical supply system includes a first system including a first tank for storing a chemical liquid therein and a first filter connecting with the first tank by a first tube and a second tube. A third tube connects the first system with a second system. The second system includes a second tank and a second filter connecting with the second tank by a fourth tube and a fifth tube. A first vent tube connects with the first tank. A second vent tube connects with the second filter.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIGURE illustrates a schematic diagram of a chemical supply system for manufacturing semiconductor devices of the present invention.

### DESCRIPTION OF THE PREFERRED EMBODIMENT

These preferred embodiments of the present invention are now described in greater detail. Nevertheless, it should be recognized that the present invention can be practiced in a wide range of other embodiments besides those explicitly described, and the scope of the present invention is expressly not limited except as specified in the accompanying claims.

As shown in FIGURE, the embodiment of the present invention provides a chemical supply system including a first system 202 and a second system 204. The first system 202 includes a first tank 206 for storing a chemical liquid therein and a first filter 208 connecting with the first tank 206 by a first tube 210 and a second tube 212. The second system 204 includes a second tank 216 and a second filter 218. The second filter 218 connects with the second tank 216 by a fourth tube 220 and a fifth tube 222. A third tube 214 connects the first system 202 with the second system 204 for pipes the chemical liquid from the first system 202 to the second system 204. A first vent tube 224 connects the first tank 206 of the first system 202. A second vent tube 226 connects with the second tank 216 of the second system 204.

When the chemical liquid is piped from the first system 202 to the second system 204 through the third tube 214, the first vent tube 224 transports a gas into the first system 202 to present the first tank 206 from flattened due to the pressure. The chemical liquid is piped into the second tank 216 through the third tube 214, and then is piped to second filter 218 through the fourth tube 220 for filtering particles. The chemical liquid is piped between the second tank 216 and the second filter 218 through the fourth tube 220 and the fifth tube 222 until most of particles inside the chemical liquid being filtered through the second filter 218. The chemical liquid is piped from the second filter 218 through the second system 204 to utilize the chemical liquid for manufacturing semiconductor devices after most of particles inside the chemical liquid being filtered through the second filter 218. The second system 204 may include a third vent tube 228 to transport a gas into the second tank 216 when the second vent tube 226 pipes the chemical liquid from the second filter 218 for manufacturing semiconductor devices.

When most chemical liquid stored inside the second tank 216 is piped through the second vent tube 226 for manufacturing semiconductor devices, the chemical liquid stored inside the first tank 206 is piped into the second system 204 through the third tube 214. However, when the first tank 206 is almost empty, a new first tank 206 filling with the chemical liquid replaces the empty first tank 206. Some of gas remained inside the empty first tank 206 is transported into the first tube 210 before the new first tank 206 replacing the empty first tank 206. Thus gas stored inside the first tube 210 is transported to the new first tank 206 after that the new first tank 206 filling with the chemical liquid is connected with the first tube 210 and the second tube 212. The cost for treating gas remained inside the chemical supply system and some of the chemical liquid is economized because the remained gas and the chemical liquid piped by the second tube 212 can be used again without disposing of the remained gas and the chemical liquid as a waste liquid. Thus the quantity of the gas and the chemical liquid is also economized.

The chemical liquid stored inside the new first tank 206 is filtered through the first filter 208 to reduce most particles inside the chemical liquid. Therefore, the chemical liquid is filtered by two filters, i.e. the first filter 208 and the second filter 218, at least before the chemical liquid is piped through the second vent tube 226 for manufacturing semiconductor devices. The chemical liquid becomes purer because both the first system 202 and the second system 204 filter the chemical liquid. Furthermore, none of the chemical liquid stored inside the new first tank 206 is wasted because all chemical liquid is stored inside the first tank 206, filtered through the first filter 208 and piped to the second tank 216.

For controlling the whole chemical supply system, the first system 202 and the second system 204 further comprises a plurality of valves to set on the tubes. For example, valves 224′, 210′ and 212′ is turned off when a new first tank 206 replaces an empty first tank 206. For transporting gas stored inside the first tube 210 to the new first tank 206 and filtering the chemical liquid stored inside the new first tank 206 through the first filter 208, valves 224′ and 214′ are turned off and valves 210′ and 212′ are turned on. After most particles of the chemical liquid being filtered through the first filter 208, the valve 212′ is then turned off, and the valves 210′, 214′ and 224′ are turned on for piping the chemical liquid stored inside the first system 202 into the second system 204. When the second filter 218 filters the chemical liquid, the valves 214′, 226′ and 228′ are turned off, and a valve 222′ is turned on for piping the chemical liquid from the second tank 216 to the second filter 218 through the fourth tube 220, and then piping the chemical liquid from the second filter 218 to the second tank 216 through the fifth tube 222. When the second vent tube 226 pipes the chemical liquid from the second system 204 for manufacturing semiconductor devices, valves 214′ and 222′ are turned off and valves 226′ and 228′ are turned on.

Hence, when the valve 214′ is turned off, the first system 202 and the second system 204 become two independent operated systems of the chemical supply system of the present invention. When operating the second system 204 to filter the chemical liquid or pipe the chemical liquid through the second vent tube 226 for manufacturing semiconductor devices, the first system 202 can replace the first tank 206 or filter the chemical liquid through the first filter 208 at the same time. Thus the time for supplying the pure chemical liquid is reduced. Furthermore, if elements of one of the first system 202 or the second system 204 of the chemical supply system are broken down, the other system without broken elements of the chemical supply system can be operated continuously for filtering the chemical liquid, replacing the first tank 206 or piping the chemical liquid. The broken elements of one independent operated system can be replaced by new elements during operating another independent operated system of the chemical supply system thus.

For sensing the quality of the chemical liquid, the chemical supply system further includes a plurality of sensors, wherein the sensors are not shown in FIGURE. When the sensors sense that most of particles of the chemical liquid are filtered by the first filter 208 or the second filter 218, the chemical supply system can stop filtering and then pipes the chemical liquid. When the sensors sense that the chemical liquid is not pure enough, the chemical liquid is filtered by the first filter 208 or the second filter 218 continuously. By the way, the gas transported by the first vent tube 224 and the third vent tube 228 may be nitrogen.

The present invention provides a chemical supply system for economizing the cost for disposing of a wasted liquid composed of gas and some of the chemical liquid, and the quantity of gas and the chemical liquid. The chemical supply system supplies a purer chemical liquid for manufacturing semiconductor devices because the chemical liquid can be filtered through the first system and the second system both. The chemical supply system can maintain the yield for manufacturing semiconductor devices. The time for supplying the purer chemical liquid is also reduced because the first system and the second system are independent operated. Furthermore, if elements of one of the first system or the second system of the chemical supply system are broken down, the other system without broken elements of the chemical supply system can be operated continuously.

Obviously, many modifications and variations of the present invention are possible in light of the above teachings. It is to be understood that within the scope of the appended claims, the present invention may be practiced other than as specifically described herein.

Although the specific embodiments have been illustrated and described, it will be obvious to those skilled in the art that various modifications may be made without departing from what is intended to be limited solely by the appended claims.

1. A chemical supply system, comprising:
a first system including a first tank for storing a chemical liquid therein and a first filter connecting with said first tank by a first tube and a second tube;
a third tube;
a second system including a second tank and a second filter connecting with said second tank by a fourth tube and a fifth tube, wherein said third tube connects said first system with said second system;
a first vent tube connecting with said first system; and
a second vent tube connecting with said second system.

2. The system according to claim 1, wherein said first vent tube transports a gas into said first system.

3. The system according to claim 1, wherein said first tube pipes said chemical liquid from said first tank to said first filter.

4. The system according to claim 1, wherein said second tube pipes said chemical liquid from said first filter to said first tank.

5. The system according to claim 1, wherein said second tube transports a gas from said first filter to said first tank.

6. The system according to claim 1, wherein said third tube pipes said chemical liquid from said first system to said second system.

7. The system according to claim 1, wherein said fourth tube pipes said chemical liquid from said second tank to said second filter.

8. The system according to claim 1, wherein said fifth tube pipes said chemical liquid from said second filter to said second tank.

9. The system according to claim 1, wherein said second vent tube pipes said chemical liquid from said second system.

10. The system according to claim 1, further comprising a plurality of valves being set on said tubes.

11. The system according to claim 1, further comprising a plurality of sensors for sensing a quality of said chemical liquid.

12. The system according to claim 1, further comprising a third vent tube transports a gas into said second tank.

13. A chemical supply system, comprising:
a first tank storing a chemical liquid therein;
a first vent tube connecting with said first tank;
a first filter connecting with said first tank by a first tube and a second tube;
a second tank connecting with said first filter by a third tube;
a second filter connecting with said second tank by a fourth tube and a fifth tube; and
a second vent tube connecting with said second filter.

14. The system according to claim 13, further comprising a third vent tube transports a gas into said second tank.
